(19) United States
(12) Patent Application Publication
(10) Pub. No.: US 2024/0402827 A1
(43) Pub. Date: Dec. 5, 2024

(54) METHOD FOR CONTROLLING AT LEAST ONE CHARACTERISTIC OF A CONTROLLABLE OBJECT, A RELATED SYSTEM AND RELATED DEVICE

(71) Applicant: INTELLIGENT INTERNET MACHINES HOLDING, ANTWERPEN (BE)

(72) Inventors: Rudy VERBEECK, ANTWERPEN (BE); Karel CROMBECQ, ANTWERPEN (BE); Kim GOOSSENS, ANTWERPEN (BE)

(21) Appl. No.: 18/693,232

(22) PCT Filed: Sep. 21, 2021
(86) PCT No.: PCT/EP2021/075968

§ 371 Date: Mar. 19, 2024

(51) Int. Cl. G06F 3/01; B25J 13/06; G06F 3/0488; G06T 13/20

(52) U.S. Cl. CPC G06F 3/017; B25J 13/06; G06T 13/20; G06F 3/0488; G06T 2200/24

(57) ABSTRACT

The invention relates to a method, a related system and related devices for controlling at least one characteristic of a controllable object, where said method comprises the steps of capturing, by said control device, a gesture of a user, and generating, at least one curve based on said gesture captured where said at least one curve representing at least one parameter of said gesture and generating by said processing means, a control instruction based on said at least one parameter of said at least one curve in combination with certain limitations of said controllable object and controlling, by an actuating means, said at least one characteristic of said controllable object based on said control instruction.

### TECHNICAL FIELD

The present invention relates to a method for controlling at least one characteristic of an object, a related system, a related control device and a related controllable object.

### BACKGROUND ART

Currently, the controlling of an object and in particular a characteristic of such object, for instance may include control of a robotic device, generation of an animation by animating an object such as a character or an avatar wherein the controlling of a characteristic of such object being a character or an avatar may be controlling of the motion of an arm, motion of a leg, motion of a head etc. Alternatively, the controlling of an object and in particular a characteristic of such object may be the controlling of light as produced by a light source, music (or sound) as generated by a dedicated sound source or motion of a certain robotic device etc.

Traditionally, currently the production of animation, even with the current 3D animation tools, requires a lot of time and effort. One of the difficult parts in character animation specifically is to “program’ the intended timing and intensity of a particular movement. For example, a character would walk quite different when in a sad, relaxed or happy state. In currently known programming of animation production this is achieved by the process of creating keyframes being a time-consuming art and skill. Such keyframe in animation and filmmaking is a drawing or shot that defines the starting and ending points of any smooth transition. These are called frames because their position in time is measured in frames on a strip of film or on a digital video editing timeline. A sequence of key frames defines which movement the viewer will see, whereas the position of the key frames on the film, video, or animation defines the timing of the movement. Because only two or three key frames over the span of a second do not create the illusion of movement, the remaining frames are filled with “in-betweens”.

Such classic animation technique comprises the creating poses of the character. The animation software will then calculate the poses in between the “key frames” or poses set by the user to create a smooth animation. This requires a lot of work for an animator to pose the limbs, body and objects.

An alternative option for creating animations currently applied, could be to record the exact movement of a limb or body and apply this to a character. This technique is called “motion capture”. The drawback is that this technique is a one-on-one translation of the recording of discrete frames over a given period of time.

Hence, known manners for producing animations however are disadvantageous in that producing such animations is very laborious and, even using the current 3D animation tools, require a lot of time and effort.

### DISCLOSURE OF THE INVENTION

It is an objective of the present invention to provide with a method, a system and related devices for controlling at least one characteristic of a controllable object of the above known type, but wherein the characteristics of such object are controlled in a very easy and intuitive manner.

In particular it may be an additional objective of the present invention to provide with a method and a device for controlling at least one characteristic of a controllable object of the above known type, but where an object is a virtual object such as an avatar or character enabling to control characteristics of such avatar in such manner creating animations in a very easy and intuitive manner.

According to the present invention this object is achieved by the method, the system, the related control device, remote server, the controllable object as described in respective claims 1, 2 and claims 6 to 14.

Indeed, by first capturing a gesture of a user of a control device, which gesture indicates an intention of a user, and subsequently generating at least one multidimensional curve such as a 2-Dimensional or 3-Dimensional curve based on said gesture of said user, where said curve represents at least one parameter of said gesture of said user and by subsequently generating a control instruction based on said at least one parameter of said at least one curve in combination with certain limitations of said object and finally controlling said at least one characteristic of said object based on said control instruction generated.

Such a gesture of a user may be captured using a capturing means CAM such as a touch screen and/or at least one camera for capturing such a gesture of a user together with an intensity of such gesture, where in case of a touch screen the pressure of the touching on the screen may be a measure of the intensity.

Alternatively, or additionally, in case of at least one camera as a capturing means, the distance between the hand or face of the user, with which the user makes the gesture, and the camera may be a measure of the intensity of the gesture.

Based on this gesture, captured by means of a capturing means, at least one multidimensional curve such as a 2-Dimensional or 3-Dimensional curve is generated, where this at least one curve represents at least one parameter of said gesture. The gesture of the user for instance being a movement, e.g. a swipe, a hand-or face-gesture over a predetermined period of time where the movement is being recorded as a set of points in time and space as shown in FIG. 4. The movement of such gesture is characterized by a beginning and an end of the curve connecting these points. The points may hold information as to location (x, y, z), speed, direction and additionally the intensity.

Such gesture may be decomposed into a distinct curve for each parameter of the gesture. For example, a distinct curve is generated for each parameter, x, y, z, speed, direction and/or intensity. Alternatively, such gesture may be decomposed into at least one curve where each curve comprises a subset of parameters of said gesture. For example, a distinct curve is generated for the x, y, z parameters, and a curve for the intensity is generated.

Subsequently, based on said at least one parameter of said at least one curve in combination with an optional limitation of said object a control instruction is generated, where such control action instruction can be applied for controlling the meant characteristic of the controllable object.

Alternatively or additionally such gesture may be captured and processed for each subsequent portion of the entire gesture where for each such portion of the gesture this portion is processed immediately after capturing by the processing means in order to determine a corresponding portion of the at least one curve for which a control instruction may be generated in order to be able to instruct an actuation means to start e.g. generating the partial animation based on the partial control instruction. The final animation hence comprises a sequence of subsequent partial animations. Advantageously, the final or full animation is generated with a decreased latency.

The same of course is valid for the control of other objects wherein the gesture is similarly processed, i.e. partially resulting in a partial control instruction for further controllable devices like robotic devices and other controllable devices.

Finally, an actuating means AM is configured to execute the control instruction and perform this corresponding control action by adapting the at least one characteristic of said controllable object based on said control instruction, where this characteristic may be a position, a movement or a deformation of an object or a part thereof in case of a virtual object such as an avatar or character. Based on the control instruction the actuation means may cause the object or part thereof to move as defined by the control action, like moving the virtual object from point A to point B, moving a body part of such avatar: moving an arm, leg, head, change its face expression etcetera to obtain an animated virtual object, where said animated virtual object can be presented at a display of a user computing device.

Consequently, using such gestures of a user can be applied for easily controlling a character's movements and quickly generate animated movies at a record speed.

Such limitation of the object in case of an animation may be that the curve can move for example an arm over a time frame following a curve, which is derived from the gesture input, where the movement of the arm is limited by physical constraints of an arm and by the associated shoulder.

The actuation means AM further comprises an animation engine that is configured to execute forward kinematics and/or an inverse kinematics algorithm for generating the factual animation further based on the mentioned control instructions generated by the processing means PM.

In case of animations of facial expressions, a library of morph targets is used, where such morph targets are selected further based on the control instructions generated by the processing means PM. Such “morph target” may be a deformed version of a shape. When for instance applied to a human face, the head is first modelled with a neutral expression and a “target deformation” is then created for each other expression. When the face is being animated, the animator can then smoothly morph (or “blend”) between the base shape and one or several morph targets. Typical examples of morph targets used in facial animation is a smiling mouth, a closed eye, and a raised eyebrow.

In case such an object is a robotic device, such as a humanoid robot, robot home servant, a lawn mowing device or a drone, based on the control instructions the actuation means may cause the object or part thereof to move as defined by the control instruction and the corresponding control action, like moving the object from point A to point B, moving a body part of such robotic device: moving any kind of actuator such as limbs (legs or arms) or wheels of such robotic device, where the limitations are being determined depending on the kind of actuators and the degrees of freedom of the type of robotic device.

In case of a light source such limitation may be the limitation of the frequency of the light to the bandwidth of visible light only meaning that the frequency of the light applied by the light source is limited to the part of the bandwidth of the light being visible.

In case of sound or audio source such limitation may be the limitation of the frequency of the sound or audio to the bandwidth of audible sound only meaning that the frequency of the sound or audio applied by the sound or audio source is limited to the part of the bandwidth of the sound being audible by people or alternatively by animals only.

Alternatively, such an actuation means AM may be based on the control instruction to instruct a light source or sound source to change characteristics of respectively light or sound, i.e. change the colors, the brightness the image shown of the light source or manipulate a sound or create new sounds.

A gesture may be a swipe on a touchscreen, a hand gesture or even a face gesture in front of a capturing device (such as a camera, or multiple cameras), where such gesture is a 2-dimensional or 3-dimensional movement having unique characteristics. This movement of the corresponding gesture of the user can be characterized by a plurality of parameters which are captured by the capturing means (such as a touch screen or camera). These parameters for characterizing the gesture may include a series of location coordinates (x, y, z), a speed of the gesture (v) a direction of the gesture (D) and furthermore an intensity (I) of the gesture of the user as is shown in FIG. 4.

Such a gesture of a user may be captured using a capturing means CAM such as a touch screen and/or at least one camera for capturing such a gesture of a user together with an intensity of such gesture where in case of a touch screen the pressure of the touching the screen may be a measure of the intensity. Alternatively, or additionally, in case of at least one camera as a capturing means, the distance between the hand or face of the user with which the user makes the gesture and the camera may be a measure of the intensity of the gesture.

Based on such gesture a processing means PM generates at least one curve, one curve for each parameter being captured. Each parameter being captured, such as the gesture location coordinates: (x, y, z), speed, and/or intensity may be described by a distinct curve. Consequently, a plurality of curves is generated, hence based on such a gesture a set of curves may be generated.

According to a further embodiment of the invention said controllable object is a virtual object in a virtual environment for presentation at display of the control device e.g. being a user device, said method and a characteristic of said virtual object may be a position, a motion and/or a deformation of said virtual object or a part thereof.

Alternatively or additionally such gesture may be captured and processed for each subsequent portion of the entire gesture where for each such portion of the gesture this portion is processed immediately after capturing by the processing means in order to determine a corresponding portion of the at least one curve for which a control instruction may be generated in order to be able to instruct an actuation means to start generating the partial animation based on the partial control instruction. The final animation hence comprises a sequence of subsequent partial animations. Advantageously, the final or full animation is generated with a decreased latency.

In this embodiment, based on a control instruction the actuation means AM causes a virtual object or a part thereof to make a movement and in this way generating an animation of such virtual object in a virtual environment, e.g. move the virtual object from point A to B and/or move at the same time an arm of such virtual object up and down and/or change the face expression of such virtual object like an avatar going from point A to Point B.

According to another embodiment of the invention said object is a virtual object is a light source and a characteristic of said light source is a characteristic of the light emitted by said light source. In this embodiment a control action causes an object being a (virtual) light source to adapt or manipulate the light emitted by the source in color in brightness or direction and/or focus.

When a user creates a movement within a given time frame, a multidimensional curve is created. By recording the speed, direction, and intensity of this curve, we can translate this into a movement of a limb, head, face, entire body or the movement of an virtual controllable object or multiple characters.

In alternative embodiment of the present invention said controllable object is a sound source and a characteristic of said sound-source is a characteristic of the sound produced by said sound source.

In still an alternative embodiment of the present invention the controllable object is a robotic device and a characteristic of said robotic device is a position and/or a motion of said robotic device or a part thereof.

Further examples of controllable objects may be a heat source, a vehicle, a smoke generator, a singing fountain with light and sound, robots etc.

### BRIEF DESCRIPTION OF THE DRAWINGS

The invention will be further elucidated by means of the following description and the appended figures.

FIG. 1 represents the System for controlling at least one characteristic of a controllable object in accordance with embodiments of the present invention including a control device CD;

FIG. 2a represents the System for controlling at least one characteristic of a controllable object in accordance with embodiments of the present invention including a control device CD, a separate remote server RS and a distinct controllable object CO with a distributed functionality;

FIG. 2b represents the System for controlling at least one characteristic of a virtual object in accordance with embodiments of the present invention including a control device CD, a separate remote server RS with distributed functionality;

FIG. 3 represents the System for controlling at least one characteristic of a controllable object in accordance with embodiments of the present invention including a control device CD and a distinct controllable device CO;

FIG. 4 represents a gesture of the user over a predetermined period of time where the movement is being recorded as a set of points in time and space;

FIG. 5 represents a curve as generated based on a captured gesture of a user according to a first embodiment;

FIG. 6 represents a curve as generated according to a second embodiment;

FIG. 7 represents a curve as generated according to a third embodiment;

FIG. 8 represents a curve as generated according to a fourth embodiment, and

FIG. 9 represents a curve as generated according to a fifth embodiment.

### MODES FOR CARRYING OUT THE INVENTION

The present invention will be described with respect to particular embodiments and with reference to certain drawings, however, the invention is not limited thereto but only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

The above and other objects and features of the invention will become more apparent and the invention itself will be best understood by referring to the following description of an embodiment taken in conjunction with the accompanying drawing.

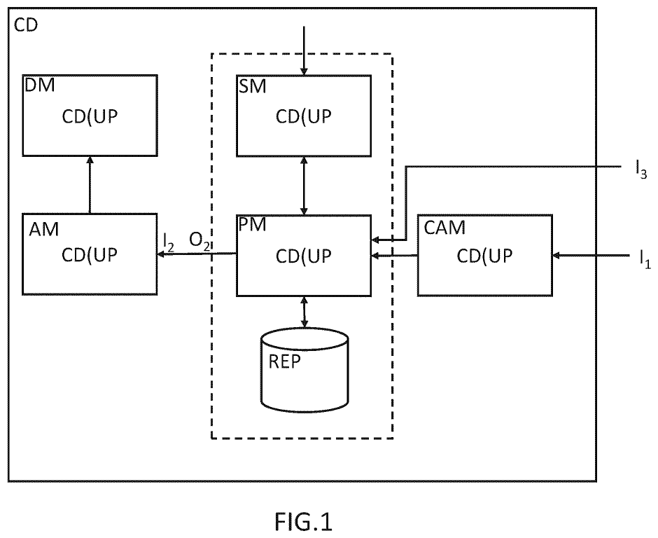

In the following paragraphs, referring to the drawing in FIG. 1 an implementation of the system is described. In the second paragraph, all connections between mentioned elements are defined.

Subsequently all relevant functional means of the mentioned system as presented in FIG. 1 are described followed by a description of all interconnections. In the succeeding paragraph the actual execution of the communication system is described.

A first essential element of the system for controlling at least one characteristic of a virtual object is the control device CD.

The control device CD according to an embodiment of the present invention may be a user computing device such as a personal computer, a mobile communications device like a smart phone, a tablet or the like or alternatively a dedicated device having a touch screen or a camera which are suitable for capturing gestures of a user of such computing device.

Such a user computing device may be a personal computer or a mobile communications device both having internet connectivity for having access to a virtual object repository or any other communications device able to retrieve and present virtual objects to a user or storing media assets in the virtual object repository forming part of a storage means of the control device or alternatively being stored at a remote repository remotely located.

The control device comprises a capturing device CAM that is configured to capture a gesture of a user. The capturing device CAM that is configured to capture a gesture of a user may be the touchscreen of the user device or one or more cameras incorporated or coupled to the control device.

The control device CD further comprises a processing means PM that is configured to generate at least one multidimensional curve such as a 2-Dimensional or 3-Dimensional curve based on said gesture of said user captured, where the generated curve represents at least one parameter of said gesture of the user. The processing means PM further is configured to generate a control instruction based on said at least one parameter of said at least one curve in combination with certain limitations of said object. The processing means PM may be a micro-processor with coupled memory for storing instructions for executing the functionality of the control device, processing steps and intermediate results.

The control device CD further comprises a storage means SM for storing data such as program data comprising the instructions to be executed by the processing means for performing the functionality of the processing means and furthermore the data generated by the capturing means and all processed data resulting directly or indirectly from the data generated by the capturing means. The storage means SM further may comprise information on the object to be controlled. Alternatively, there may be a repository REP to store information on the objects to be controlled such as virtual objects or real physical controllable objects like robotic devices, audio and light sources or further controllable objects.

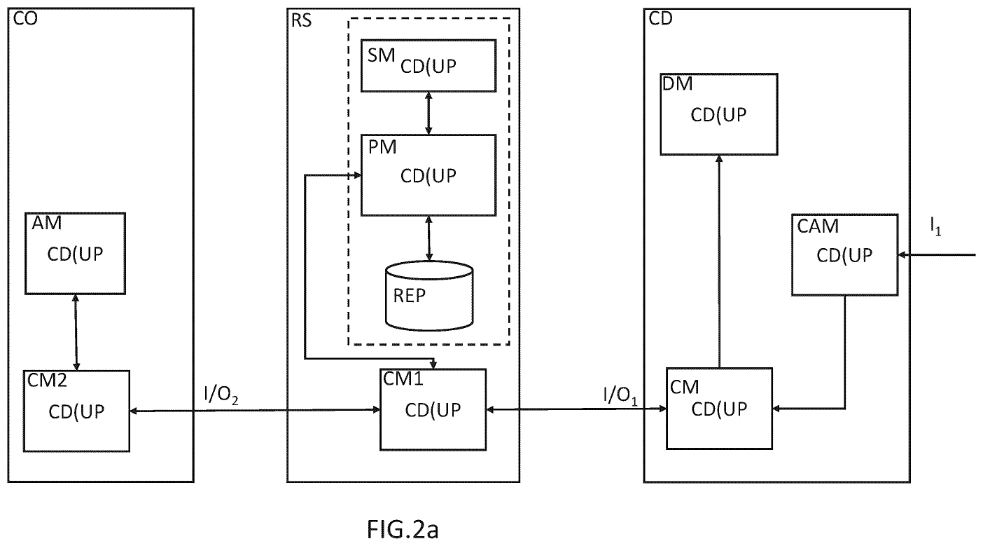

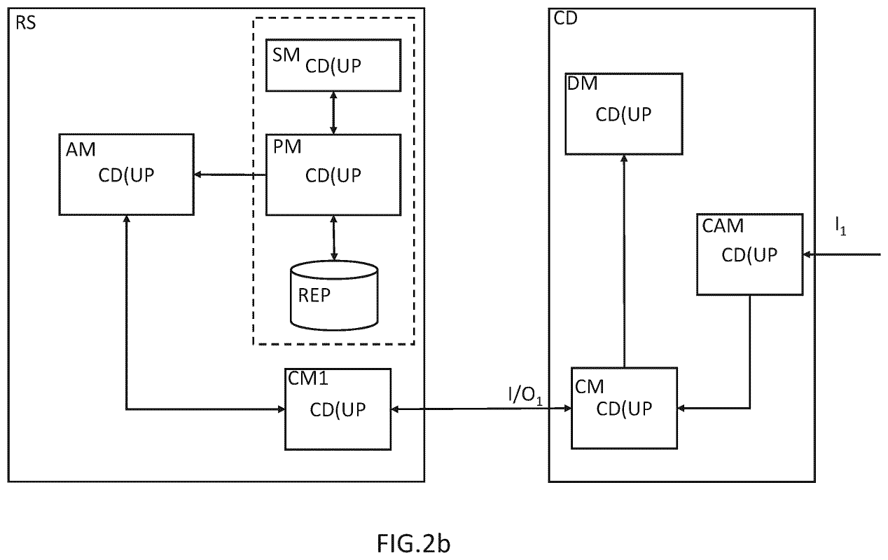

In a further embodiment of the present invention, the functionality of the system for controlling at least one characteristic of a controllable object CO according to the present invention, is distributed over a remote server RS being a server device configured to perform the functionality of the processing means PM, controlling the controllable object CO and/or the functionality of the Storage means SM and/or repository REP as is shown in FIG. 2a.

The control device in this embodiment comprises a capturing means CAM that is configured to capture a gesture of a user and a communications means CM configured to communicate the gesture of a user as captured to the communications means CM1 of the remote server RS that in turn is configured to receive said gesture of a user of said control device and said processing means PM being first configured to generate at least one curve based on said gesture captured, said at least one curve representing at least one parameter of said gesture and the processing means PM additionally is configured to generate a control instruction based on said at least one parameter of said at least one curve in combination with certain limitations of said object where said communications means CM1 further is configured to communicate said instruction based on said at least one parameter of said at least one curve in combination with certain limitations of said object to the actuation means AM of the controllable device CO via a communications means CM2 of the controllable object CO.

The respective communications means are coupled over a communications link as a wireless or fixed connection such as wireless networks include cell phone networks, wireless local area networks (WLANs), wireless sensor networks, satellite communication networks, wireless or fixed internet protocol network or any alternative suitable communications network.

Alternatively, for instance in case the controllable object CO is a virtual object, said at least one curve generated based on said gesture captured is processed by the actuation means incorporated in the Remote server RS, where the actuating means AM, controls said at least one characteristic of said controllable object CO based on said control instruction and factually may generate an animation, where this remote server may be a web server having generated a web-based animation. This web based animation subsequently is retrieved or pushed via respective communications means CM1 of the remote server RS and the communications means CM of the control device CD and subsequently rendered at a display means of the control device CD as is shown in FIG. 2b.

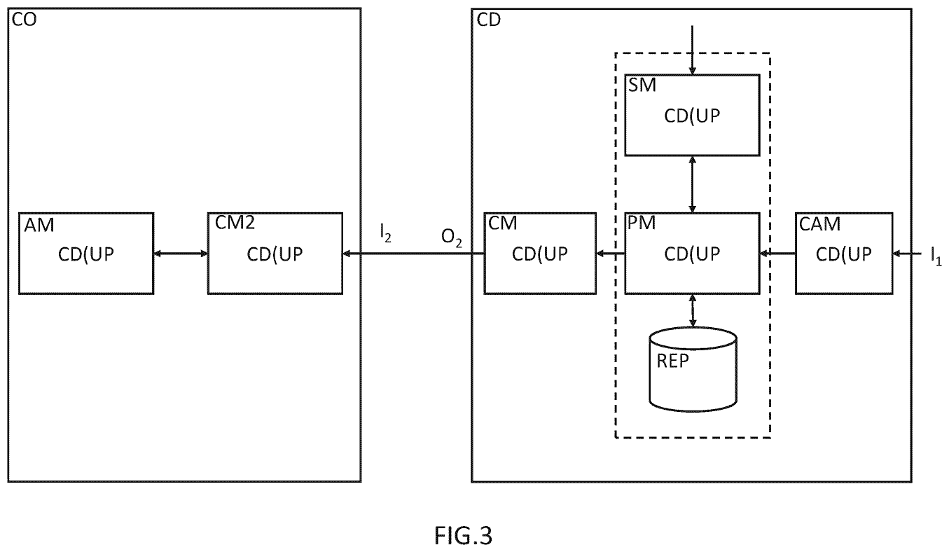

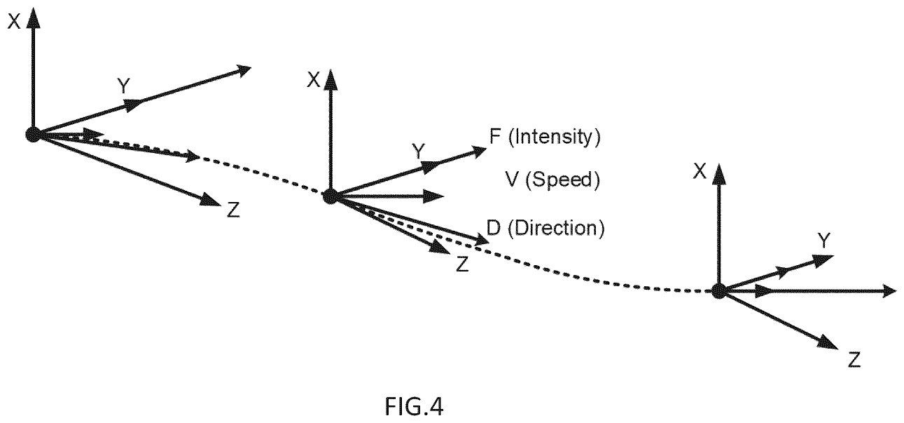

In a still further embodiment of the present invention the functionality of the system for controlling at least one characteristic of a controllable object CO according to the present invention is distributed over the control device CD and the controllable object CO as shown in FIG. 3.

Further such system for controlling at least one characteristic of a controllable object CO may comprise an actuating means AM, that is configured to control said at least one characteristic of said object based on said control instruction defining a control action. The actuating means AM may be incorporated in the control device CD, but may alternatively be incorporated in a separate controllable object CO as shown in FIG. 2a or 3 or alternatively in a remote server RS.

The actuation means AM may be implemented by a similar or the same micro-processor with coupled memory for storing instructions for executing the functionality of the control device, processing steps and intermediate results or be a dedicated separate microprocessor for executing the required functionality corresponding the actuation means functionality.

The actuation means AM further comprises an animation engine, being executed by or under control of the mentioned microprocessor with coupled memory, that is configured to execute forward kinematics and/or an inverse kinematics algorithm for generating the factual animation further based on the mentioned control instructions generated by the processing means PM.

In case of animations of facial expressions, the actuation means AM applies, a library of morph targets is used where such morph targets are selected further based on the control instructions generated by the processing means PM. Such “morph target” may be a deformed version of a shape. When for instance applied to a human face, the head is first modelled with a neutral expression and a “target deformation” is then created for each other expression. When the face is being animated, the animator can then smoothly morph (or “blend”) between the base shape and one or several morph targets. Typical examples of morph targets used in facial animation is a smiling mouth, a closed eye, and a raised eyebrow.

The control device CD may further comprise a display means DM being a display for rendering or displaying a virtual object where the display means may be the display of the computing device, e.g. the screen of the personal computer or the mobile computing device.

The capturing device CAM is coupled with an output to an input of the processing means PM that in turn is coupled with an output O₂ to an input I₂ of the actuating means AM. The storage means SM is coupled with an input/output to an input/output of the processing means PM. The capturing means CAM alternatively or additionally may also be coupled to the storage means for directly storing the data generated by the capturing device CD (not shown in the Figure).

Alternatively, the functionality of the processing means PM and/or the actuation means AM may be implemented in a distributed manner, as is shown in FIG. 2a, FIG. 2b and FIG. 3 in which embodiments the processing means PM may be implemented in an intermediate network element such as a remote server RS being coupled to the control device and coupled to the controllable device over a communications link as a wireless or fixed connection such as wireless networks include cell phone networks, wireless local area networks (WLANs), wireless sensor networks, satellite communication networks, wireless or fixed internet protocol network or any alternative suitable communications network.

In order to explain the present invention, it is assumed that the control device CD of the user is a smartphone where a certain object, in this embodiment for instance being a virtual object such as an avatar or character of a person, being displayed at the display of the control device, i.e. the smartphone, as is shown in FIG. 5.

It is further assumed that the user wishes to generate an animation of the mentioned virtual object, being the shown avatar.

In this case the intent of the user is to create an animation of the meant virtual object walking along a path from point A to point B, as shown in FIG. 5.

This intent can be set either prior to the user having made the gesture or afterwards, where it is assumed that the characteristic to be controlled is, at a user's choice, the motion of the virtual object over an indicated straight path from A to B.

The intent could be indicated over a dedicated signal being received over a dedicated user input I₃.

As the user makes a gesture on the touch screen of the control device CD, which is shown in FIG. 5, the gesture at first is captured by means of the touch screen CAM.

Subsequently, the processing means PM generates at least one 2-Dimensional (or 3-dimensional) curve based on said captured gesture of the user, where said curve in the current setting represents at least one parameter of said gesture being in this particular embodiment the location of the virtual object, i.e. the (x, y) coordinates and the deduced speed of the movement of virtual object which is derived from the gesture of the user.

Based on this at least one parameter, in this particular embodiment being the location of the virtual object, i.e. the (x, y) coordinates and the deduced speed of the movement of virtual object, the processing means PM subsequently generates a control instruction comprising an instruction for moving the virtual object moving from point A to B along a straight path that is correlated or transposed from the speed of the gesture over the time frame, making the character walk faster, run, slow down and stop again at point B.

Subsequently, the control instruction is applied by the actuation means AM to accordingly move the virtual object from location A to location B along a straight path, where speed of the movement of the virtual object is controlled in correlation with the speed of the gesture, making the character walk faster, run, slow down and stop again at point B.

This movement of the virtual object according to the meant instruction and actuation by the actuation means AM is accordingly rendered at the presentation means, i.e. the display of the control device, i.e. a smartphone.

In generating this animation, the actuation means AM executes forward kinematics and/or an inverse kinematics algorithms for generating the factual animation further based on the mentioned control instructions generated by the processing means PM.

In a second, alternative embodiment of the present invention, the same gesture of the user can also be applied in a different, alternative manner by applying other parameters from the captured gesture of the user and subsequently controlling alternative characteristics of such virtual object.

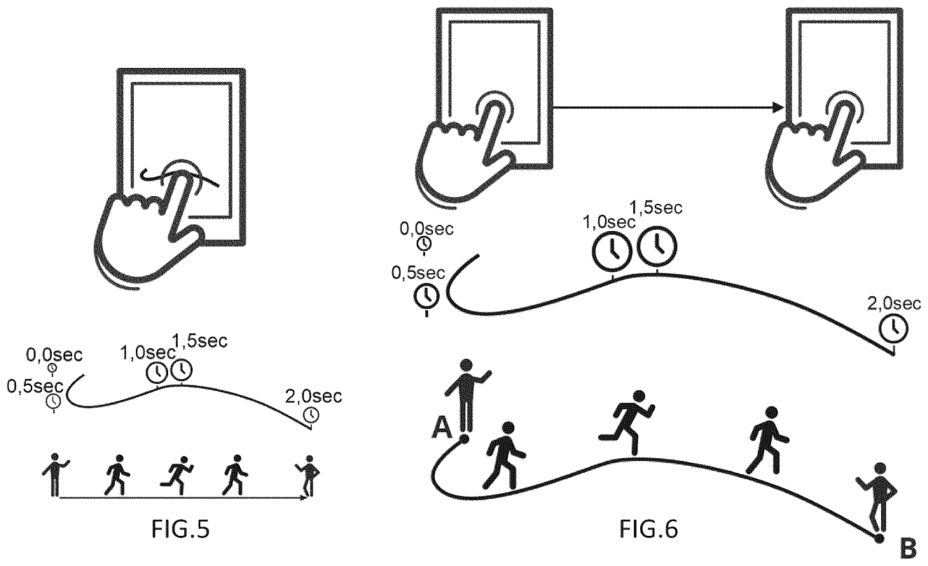

As the user makes a gesture on the touch screen of the control device, which is also shown in FIG. 6, this gesture at first is captured by means of the touch screen. Subsequently, the processing means PM generates at least one 2-Dimensional curve based on said captured gesture of the user, where said curves now in the current setting represent at least one parameter of said gesture, being in this particular embodiment the location of the virtual object, i.e. the (x, y) coordinates, the deduced speed of the movement of virtual object which is derived from the gesture of the user together with the intensity of the gesture which in this particular embodiment of the present invention is the pressure with which the user presses the touch-screen.

Based on these parameters, in this particular embodiment, being the location of the virtual object, i.e. the (x, y) coordinates and the intensity of the gesture of virtual object, the processing means PM subsequently generates a control instruction comprising an instruction for moving the virtual object from point A to B on a curved path as indicated, where the shape of the swipe, i.e. the (x, y) coordinates are being used to determine the path of the virtual object and the captured intensity of the gesture the time as an indication for the speed. As a consequence, the processing means PM bases the location and the path of the virtual object to be followed on the captured (x, y) coordinates of the gesture of the user and the speed of the gesture over the time is correlated with intensity of the gesture making the animation of the character walk faster, run, slow down and stop again at point B.

Subsequently, the control instruction is applied by the actuation means AM to accordingly move the virtual object from location A to location B along a curved path where speed of the movement of the virtual object is controlled in correlation with the intensity of the gesture, making the animation of the character walk faster, run, slow down and stop again at point B based on the pressure executed by the user while making the gesture on the touchscreen.

This movement of the virtual object according to the meant instruction and actuation by the actuation means is accordingly rendered at the displaying means DM, i.e. the display of the control device, i.e. a smartphone.

In a third, alternative embodiment of the present invention, the gesture of the user can also be applied in a further different and alternative manner by applying other parameters from the captured gesture of the user and subsequently controlling alternative characteristics of such virtual object.

It is again assumed that the user of the control device CD wishes to generate an animation of the mentioned virtual object, being the shown avatar.

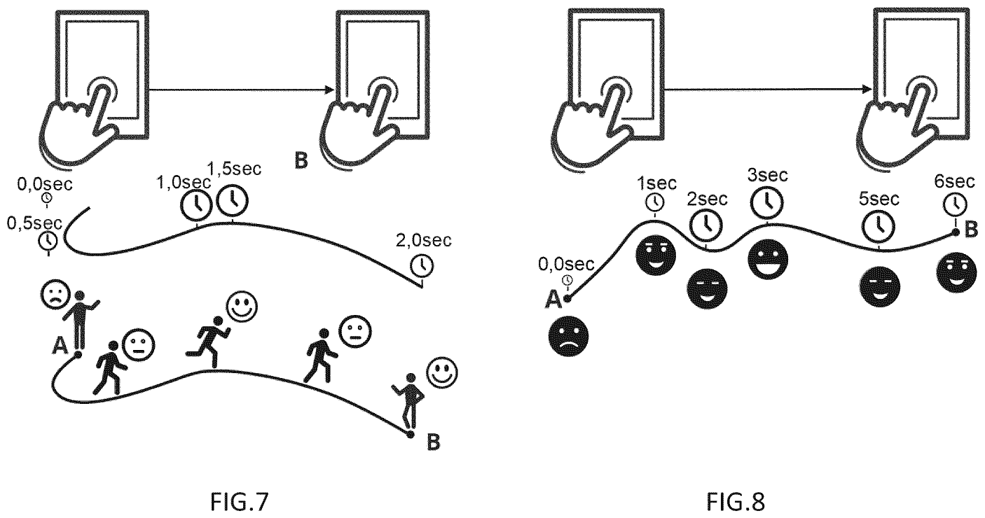

In this case the intent of the user is to create an animation of the meant virtual object walking along a path from point A to point B, as shown in FIG. 7, wherein the shape of the curve can be used to control the speed of the character, while at the same time the intensity of the curve is applied to control the mood of the character while walking.

In case of animations of facial expressions, the actuation means AM applies a library of morph targets, where such morph targets are selected further based on the control instructions generated by the processing means PM. Such “morph target” may be a deformed version of a shape. When for instance applied to a human face, the head is first modelled with a neutral expression and a “target deformation” is then created for each other expression.

As the user makes a gesture on the touch screen of the control device as shown in FIG. 7, this gesture at first is captured by means of the touch screen.

Subsequently, the processing means PM generates at least one 2-Dimensional curve based on said captured gesture of the user, where said at least one curve now in the current setting represents at least one parameter of said gesture being in this particular embodiment the speed of the virtual object, where this speed of the movement is deduced from the (x, y) coordinates of the gesture of the user at the touch screen and additionally the intensity of the gesture which in this particular embodiment of the present invention is the pressure with which the user presses on the touchscreen.

Based on these captured parameters, in this particular embodiment, being the speed of the virtual object and the intensity of the gesture of the user, the processing means PM subsequently generates a control instruction being an instruction destined to the actuation means AM for moving the virtual object moving from point A to B on a path as shown, where the shape of the gesture, e.g. a swipe, i.e. the speed deduced from the (x, y) coordinates is being used to determine the speed of the virtual object and the captured intensity of the gesture is applied as an indication for the mood of the character.

As a consequence, the processing means PM in generating the control instruction bases the speed of the virtual object on the speed deduced from the captured (x, y) coordinates of the gesture of the user at the touch screen and the speed of the gesture over the time is correlated with speed of the animation of the character, causing the character to walk faster, run, slow down and stop again at point B.

Additionally, the processing means PM in generating the second part of the control instruction bases the mood of the virtual object on the intensity of the gesture of the user and the intensity of the gesture over the time is correlated with the mood of the character making the animation of the character with a sad face, neutral face, happy face, neutral face and happy face again.

Subsequently, the control instruction is applied by the actuation means AM to accordingly move the virtual object from location A to location B along a path where speed of the movement of the virtual object is controlled in correlation with the speed of the gesture, making the animation of the character walk faster, run, slow down and stop again at point B based on the pressure executed by the user, while making the gesture on the touchscreen and at the same time of the movement of the character the actuation means AM to accordingly move the virtual object from location A to location B, where the animation of the mood of the character is based on the intensity of the gesture of the user and the intensity of the gesture over the time is correlated with the mood of the character making the animation of the character with a sad face, neutral face, happy face, neutral face and happy face again walking from point A to point B.

This movement of the virtual object according to the meant instruction and actuation by the actuation means is accordingly rendered at the displaying means DM, i.e. the display of the control device, i.e. a smartphone.

In a fourth alternative embodiment of the present invention, the gesture of the user can also be applied in still further alternative manner by applying other parameters from the captured gesture of the user and subsequently controlling alternative characteristics of such virtual object.

It is again assumed that the user wishes to generate an animation of the mentioned virtual object being the shown character or avatar.

In this case the intent of the user is to create an animation of the meant virtual object, wherein the gesture of the user can also be used to control a part of the character, i.e. the set of curves is applied to control a facial expression of a character that changes over a certain predetermined time frame.

In this case the position of the curve can be used to influence the facial expression. A lower position could mean a sad mood, while a higher position could mean a happier mood.

Of course, any parameter of the curve could be used to control the expression.

Alternatively, also further expressions can be used, or even parts of the face, such as eyes, eyebrows, chin, etc. can be animated in correlation with the shape of the curve.

Again, in this particular embodiment of the present invention, the capturing device CAM captures the gesture of a user where this gesture is shown in FIG. 8. The x, y coordinate of the curve gesture at the touch screen of the control device, i.e. the mobile device are captured.

This intent can be set either prior to the user has made the gesture or after, where it is assumed that the characteristic to be controlled, at a user's choice, can be used to influence the facial expression of the character. Control input I₃ could be applied to provide the processing means PM with a selection signal for selecting the particular characteristic to be controlled based on the gesture of the user. The particular characteristic may be the mentioned facial expression, but alternatively at the user's choice be parts of the face, such as eyes, eyebrows, chin, etc. can be animated in correlation with the shape of the curve.

Subsequently the processing means PM generates a control instruction based on said gesture captured, where said curve representing the x, y coordinates, where the y coordinate is a measure that is used to influence the facial expression. A lower position could mean a sad mood while a higher position a happier mood. Based on the generated curve, the processing means PM further generates a control instruction that being an instruction for use by the actuation means, to influence the facial expression

Finally, the actuating means AM of the control device CD controls the mood of the character, i.e. the object based on said control instruction as generated by the processing means PM of the control device, i.e. the smart phone.

This movement of the virtual object according to the meant instruction and actuation by the actuation means is accordingly rendered at the displaying means DM, i.e. the display of the control device, i.e. a smartphone.

In still a further alternative embodiment of the present invention, the gesture of the user can also be applied in still further alternative manner by applying other parameters from the captured gesture of the user and subsequently controlling alternative characteristics of such virtual object.

The generated curve, as generated based on the gesture made by a the user at the touch screen can also be used to control the movement of body parts such as limbs, feet, fingers, toes, pelvis, neck and so on.

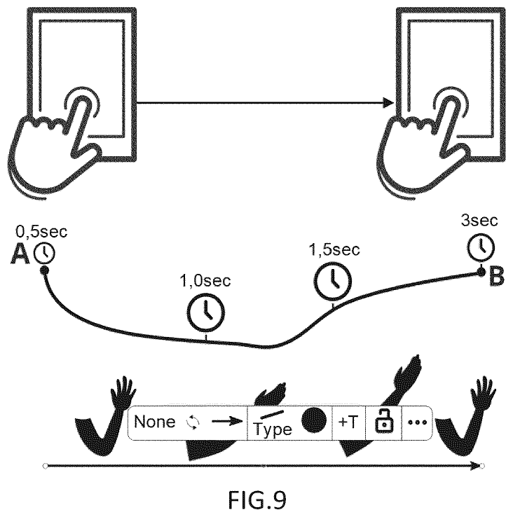

It is again assumed that the user wishes to generate an animation of the mentioned virtual object being the shown character or avatar, wherein in this particular embodiment, an example of an arm movement is disclosed whereby the duration and the movement of the arm is being controlled by applying the curve as is shown in FIG. 9 to the joints of the arm.

The physical location can be used to determine the rotation of the arm, and the timing of the swipe the speed at which the rotation takes place.

As we have seen in previous examples, we can also use different sets of the curves to control different parts of the movement.

Summarizing, each set of parameters derived from the gesture of the user can be converted into a curve and each of the curves can be used to change a parameter in the movement of the character, either in speed, location (path), mood, or otherwise.

An alternative embodiment is that the actuation means AM is incorporated in a separate, dedicated controllable object CO that based on a control instruction generated by a control device CD is configured to execute this control instruction by the actuation mean AM incorporated in said controllable object CO.

A further alternative embodiment is that instead of a virtual object, a real physical controllable object comprising dedicated elements is controlled in a similar manner as described for virtual objects like a robotic device having certain actuators for executing certain dedicated tasks.

Such controllable object like a robotic device may be a human looking device being able to move, using wheels and possessing actuators to perform dedicated functionality using dedicated actuators such as a tool arm, or alternatively be a mowing device, a robotic cleaning device, or a flying robotic devices, such as a drone.

As described for the embodiments relating to the virtual object, these embodiments could likewise be applied to a physical object, like a robotic device being able to move by means of associated wheels or and be able to perform certain tasks by means of certain actuators for performing dedicated tasks. In such embodiments likewise certain predetermined parameters of a gesture of a user are applied to control predetermined functions of such robotic device.

In the situation of such a controllable object such as a robotic device, a controllable light or audio source, these devices may be configured to receive the dedicated control instructions and be configured with an actuating means AM to execute the received control instruction.

In order to explain the present invention, it is assumed that the control device CD of the user for instance is a smartphone with a dedicated control application or be a dedicated control device for controlling such a robotic device. The control device for controlling at least one characteristic of an object comprises an actuating means AM that is configured to forward said control instruction towards a dedicated actuating device AM2 that is configured to control said at least one characteristic of said object, i.e. the robotic device, the light source or the sound source based on the received control instruction.

The controllable object CO, e.g. a robotic device comprises a communications means CM that is configured to receive said control instruction for controlling said at least one characteristic of said controllable object (CO) based on said control instruction from the control device CD and an actuating means AM that is configured to control said at least one characteristic of said controllable object CO based on said control instruction.

It is further assumed that the user wishes to control such robotic device like a robot home servant and let this robotic device move along a path as determined based on the gesture of the user and moreover control further actuators of such robotic device to perform functions like opening a lid from a jar, moving objects etc.

In this particular embodiment case the intent of the user is to guide the robotic device to move from point A to point B, similar to a path as shown in FIG. 5 or FIG. 6.

This intent can be set either prior to the user has made the gesture or after, where it is assumed that the characteristic to be controlled is, at a user's choice, the motion of the virtual object over an indicated straight path from A to B. The user by means of a signal can indicate the intention of the gesture meaning the indication how the gesture is to be interpreted how the characteristic of the controllable object is to be changed.

As the user makes a gesture on the touch screen of the control device, which is shown in FIG. 5, the gesture at first is captured by means of the touch screen.

Subsequently, the processing means PM generates at least one 2-Dimensional (or 3-Dimensional in case of a flying robotic device) curve based on said captured gesture of the user, where said curve in the current setting represents at least one parameter of said gesture being in this particular embodiment the location of the object, i.e. the (x, y) (or x, y, z in case of a flying device) coordinates and the deduced speed of the movement of virtual object which is derived from the gesture of the user.

Based on this at least one parameter, in this particular embodiment being the location of the controllable object CO, i.e. the (x, y) coordinates and the deduced speed of the movement of the controllable object CO, the processing means PM subsequently generates a control instruction being an instruction for moving the object, i.e. the robotic device moving from point A to B on a straight path that is correlated or transposed from the speed of the gesture over the time frame, making the robotic device move faster, speed up, slow down and stop again at point B.

Subsequently, the control instruction is forwarded towards the communications means CM of the controllable object CO in this embodiment being implemented by a robotic device CO and subsequently the control instruction is applied by the actuation means AM2 to accordingly move the object from location A to location B along a straight path where speed of the movement of the controllable object CO is controlled in correlation with the speed of the gesture, making the character walk faster, run, slow down and stop again at point B.

Alternatively, or additionally, in case of at least one camera as a capturing means, the distance between the hand or face of the user, with which the user makes the gesture, and the camera may be a measure of the intensity of the gesture.

1-14. (canceled)

15. A method for controlling at least one characteristic of a controllable object (CO) by means of a control device (CD), said control device (CD) being coupled to said controllable object (CO) over a communications link, said method comprising the steps of:
capturing, by a capturing means of said control device, a gesture of a user;
generating, by a processing means (PM), at least one curve based on said gesture captured, said at least one curve representing at least one parameter of said gesture, said parameters of said gesture comprising at least one of: x-coordinate, y-coordinate, z-coordinate, speed, direction and/or intensity of said gesture captured; and
generating, by said processing means (PM), a control instruction based on said at least one parameter represented by said at least one curve in combination with certain limitations of said controllable object; and
controlling, by an actuating means, said at least one characteristic of said controllable object based on said control instruction,
wherein said controllable object (CO) is a virtual object in a virtual environment for presentation at display of said control device (CD), said characteristic of said virtual object is a position, a motion and/or a deformation of said virtual object or a part thereof.

16. A system for controlling at least one characteristic of a controllable object (CO), said system comprising:
a control device (CD) and said controllable object (CO), said control device (CD) being coupled to said controllable device (CO) over a communications link, said control device (CD) comprising a capturing means (CAM) configured to capture a gesture of a user;
a processing means (PM), configured to generate at least one curve based on said gesture captured, said curve representing at least one parameter of said gesture, said parameters of said gesture comprising at least one of: x-coordinate, y-coordinate, z-coordinate, speed, direction and/or intensity of said gesture captured, wherein said processing means (PM) is further configured to generate a control instruction based on said at least one parameter represented by said at least one curve in combination with certain limitations of said controllable object; and
an actuating means (AM), configured to control said at least one characteristic of said controllable object (CO) based on said control instruction;
wherein said controllable object (CO) is a virtual object in a virtual environment for presentation at display of said control device (CD), said characteristic of said virtual object is a position, a motion and/or a deformation of said virtual object or a part thereof.

17. The system for controlling at least one characteristic of a controllable object (CO) according to claim 16, wherein said system additionally comprises a remote server (RS), said remote server being coupled between said control device (CD) and said controllable object (CO) each being coupled over a communications link.

18. A control device (CD) for use in the system according to claim 16, said control device (CD) comprising:
a capturing means (CAM) configured to capture a gesture of a user of said control device;
a processing means (PM) configured to generate at least one curve based on said gesture captured, said at least one curve representing at least one parameter of said gesture; and
wherein said processing means (PM) is further configured to generate a control instruction based on said at least one parameter of said at least one curve in combination with certain limitations of said controllable object.

19. The control device (CD) according to claim 18, wherein said control device (CD) further comprises:
an actuating means (AM), configured to control said at least one characteristic of said controllable object (CO) based on said control instruction.

20. The control device (CD) for controlling at least one characteristic of a controllable object (CO) according to claim 18, wherein said control device (CD) further comprises:
a communication means (CM), configured to forward said control instruction towards a controllable object (CO) configured to control said at least one characteristic of said controllable object based on said control instruction.

21. A controllable object (CO) for use in the system according to claim 16, wherein said controllable object comprises:
a communication means (CM), configured to receive said control instruction for controlling said at least one characteristic of said controllable object (CO) based on said control instruction; and
an actuating means (AM), configured to control said at least one characteristic of said controllable object (CO) based on said control instruction.

22. A remote server (RS) for use in the system according to claim 17, wherein said remote server comprises:
a communication means (CM1), configured to receive said gesture of a user of said control device; and
a processing means (PM) configured to generate at least one curve based on said gesture captured, said at least one curve representing at least one parameter of said gesture; and
wherein said processing means (PM) is further configured to generate a control instruction based on said at least one parameter of said at least one curve in combination with certain limitations of said controllable object.

23. The remote server (RS) according to claim 22, wherein said remote server (RS) further comprises:
an actuating means (AM), configured to control said at least one characteristic of said controllable object (CO) based on said control instruction.
